(19) United States
(12) Patent Application Publication
(10) Pub. No.: US 2007/0239951 A1
(43) Pub. Date: Oct. 11, 2007

(54) Storage-centric system, backup method and backup program

(75) Inventors: Daisuke Yokota, Kawasaki (JP); Shinji Kimura, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/440,590

(22) Filed: May 22, 2006

(30) Foreign Application Priority Data
Apr. 11, 2006 (JP) 2006-108291

(51) Int. Cl. G06F 12/16

(52) U.S. Cl. 711/162

(57) ABSTRACT

A backup method in a storage-centric system includes at least one storage device including a disk as a memory device and a backup disk as a destination for data backup of the disk; computers having a main memory device; and at least one backup server for performing a process to backup data onto the backup disk. The disk, the storage device, the computers and the backup server communicate with one another via networks, at least among which data is sent and received via a communication protocol based on iSCIS. Each computer determines by itself whether or not there is any access to the computer, and as a result of the determination, if it is determined that there is no access to the computer, the computer stores memory images that are data stored on the main memory device onto the disk, and then powers off the computer by itself. Then, the backup server backs up the data stored on the disk onto the backup disk.

### CROSS-REFERENCE TO RELATED APPLICATION

This application claims the benefit of Japanese Patent Application No. 2006-108291 filed on Apr. 11, 2006, the disclosure of which is incorporated herein by reference.

1. Field of the Invention

The present invention relates to a storage centric system, a backup method for the storage centric system and a backup program executing the backup method.

2. Description of the Related Art

Recently more interests have been taken in a storage-centric system, in order to reduce administrators' labor and running cost. A storage-centric system is a system solution, by which OS (Operation System), applications and data that are normally stored on HD (Hard Disk) of a computer used in an enterprise are all converged on a bulk memory device (hereinafter referred to as “storage device”) via wide area IP (Internet Protocol) networks so that all the information on each computer can be centralizedly managed.

One of schemes realizing such a storage-centric system is iSCSI (Internet Small Computer System Interface). iSCSI is a protocol capable of building a storage-centric system via conventional TCP/IP (Transmission Control Protocol/Internet Protocol) networks, by encapsulating, into a TCP/IP packet, data and SCSI (Small Computer System Interface) commands that are a standard protocol used for connection with existing computers and peripheral equipments (See Non-patent Document 1 on further information on specifications of iSCSI protocol).

In comparison to NAS (Network Attached Storage) conventionally used in a storage-centric system, iSCSI has an advantageous feature: this scheme can be used as a boot device for database applications or OS for reading/writing data stored on a disk on a sector by sector basis. Moreover, in comparison to FC (Fibre Channel), iSCSI has another advantage: iSCSI can reduce cost on building the system. Therefore, iSCSI has been more expected as an advantageous scheme to implement a storage-centric system.

In such a storage-centric system built by adopting the iSCSI scheme as mentioned above, it is more important to prepare a backup system to coup with cases in which programs or data are broken or lost than to prepare for ordinary computer systems themselves.

There have been disclosed various schemes for data backup in a computer system, as follows.

A scheme has been disclosed, for example in Patent Document 1, in which there is provided a function to perform data backup even during executing an application.

Another data backup scheme has been disclosed, for example, in Patent Document 2, by using MRCF (Multiple RAID Coupling Feature).

As further another data backup scheme, for example, Patent Document 3 discloses a method of implementing a resume function to temporarily stop a computer after writing memory status thereof onto the disk.

Note that hibernation hereinafter denotes to “power off a computer after storing memory images”, and to “stop a computer” hereinafter denotes to “power off a computer without saving memory images”.

Recently there have been more interests in a scheme providing an integral data backup at a backend in a storage-centric system.
Patent Document 1: JP-A-2004-38934
Patent Document 2: JP-A-2004-46435
Patent Document 3: JP-B-3483906
Non-patent Document 1: Julian Satran, et. Al, “iSCSI”, “IETF”, [online], [Searched on Aug. 24, 2005], URL<http ://tools.ietf.org/wg/ips/draft-ietf-ips-iSCSI/draft-ietf-ips-iS CSI-20.txt>

However, the iSCSI scheme performs an access on a sector by sector basis and cannot handle exclusive controls on a file by file basis. Therefore, this scheme has a disadvantage that plural computers are normally not allowed to write data on a same single specific disk at a time.

In cases in which latest data may exist on a memory of a 24-hour running server or a client server which has been forgotten to be powered off, there may be a possibility that the data on the memory may be written on a disk thereof. Therefore, it cannot be insured that the data stored on the disk in this way is always in a constant state. In other words, there has been raised a problem that there is no sense to backup a disk in such a state in which data is being written thereonto.

The scheme of adding a function to backup data during executing an application, as disclosed in Patent Document 1, has a disadvantage that applications that can be used in this scheme are limited to those specific applications having this function.

A scheme disclosed in Patent Document 2 has a disadvantage that NAS or SAN (Storage Area Network) is a prerequisite for a storage device, and iSCSI protocol is not available in this scheme.

Patent Document 3 discloses a scheme to maintain a previous performing status of a computer before the hibernation, by writing data stored on a memory onto a disk in a hibernation state, and reading the data stored on the disk onto the memory when resuming from the hibernation. In this scheme, recording resume from hibernation or writing data onto a virtual memory of the disk are carried out. In Patent Document 3, although backup function becomes available when the computer goes into a stop state, those functions are missed of writing data onto the disk and excluding a backup operation while the computer is in a resume state. A resume process is for coping, onto the disk, memory images that are data stored on a main memory device, which requires more time for data copying in addition to data backup time. Since it is preferable not to stop a 24 hour-running server, increase in data backup time requiring a server stop may cause a problem.

In the light of the technical background as mentioned above, it has been requested in a storage-centric system using iSCSI that data backup operation for the disk can be performed even in a state in which an operating computer is connected with the system.

### SUMMARY OF THE INVENTION

In one aspect of the present invention, there is provided a backup method in a storage-centric system which includes at least one storage device comprising a disk as a memory device and a backup disk as a destination for data backup of the disk; computers each having a main memory device; and at least one backup server for performing a process to backup data onto the backup disk, and the disk, the storage device, the computers and the backup server communicate with one another via networks, at least among which data is sent and received via a communication protocol based on iSCIS.

The backup method comprises

allowing each computer
to determine by itself whether or not there is any access to the computer, if it is determined that there is no access to the computer,
to store memory images that are data stored on the main memory device onto the disk, and
to power off the computer by itself, and

allowing the backup server to back up the data stored on the disk onto the backup disk.

In another aspect of the present invention, there is provided a backup method in a storage-centric system which comprises at least one storage device comprising a disk as a memory device and a backup disk as a destination for data backup of the disk; computers each having a main memory device; and at least one backup server for performing a process to backup data onto a disk different from the disk.

The disk, the storage device, the computer and the backup server communicate with one another via networks, at least in which data is sent and received via communication protocol based on iSCIS.

The backup method comprises

allowing each computer to determine by itself whether or not there is any access to the computer; and

if it is determined that there is no access to the computer, allowing the computer to store memory images that are data stored on the main memory device onto the disk, and to powers off the computer by itself

In further another aspect of the present invention, there is provided a backup method in a storage-centric system which comprises at least one storage device comprising a disk as a memory device and a backup disk as a destination for data backup of the disk; computers each having a main memory device; and at least one backup server for performing a backup process onto the backup disk.

The disk, the storage device, the computers and the backup server communicate with one another via networks, at least among which data is sent and received via a communication protocol based on iSCIS.

The backup method comprises

backing up the data stored on the disk onto the backup disk after receiving from the computer a notice that a process of storing memory images that are data on the main memory device onto the backup disk has been completed.

Other features and advantages of the present invention will become more apparent from the following detailed description of the invention. When taken in conjunction with the accompanying exemplary drawings.

### BRIEF DESCRIPTION OF DRAWINGS

FIG. 1 is a schematic block diagram showing a configuration of a storage-centric system according to an embodiment of the present invention.

FIG. 2 is a schematic block diagram showing a configuration of a server and a backup server.

FIG. 3 is a schematic block diagram showing a configuration of hardware of the server.

FIG. 4 shows a structure of a status management table.

FIG. 5 shows a structure of a server/storage device address mapping table.

FIG. 6 shows a structure of an I/O process function address table that the BIOS stores.

FIG. 7 is a flow chart showing a flow of a backup process according to the embodiment of the present invention.

FIG. 8 is a flow chart showing a flow of a hibernation process of a prior art.

FIG. 9 is a flow chart showing a flow of a memory image copying process (S109 in FIG. 7).

FIG. 10 is a flow chart showing a flow of a resume from hibernation process (S118 in FIG. 7).

### DETAILED DESCRIPTION OF THE PREFERRED EMBODIMENTS

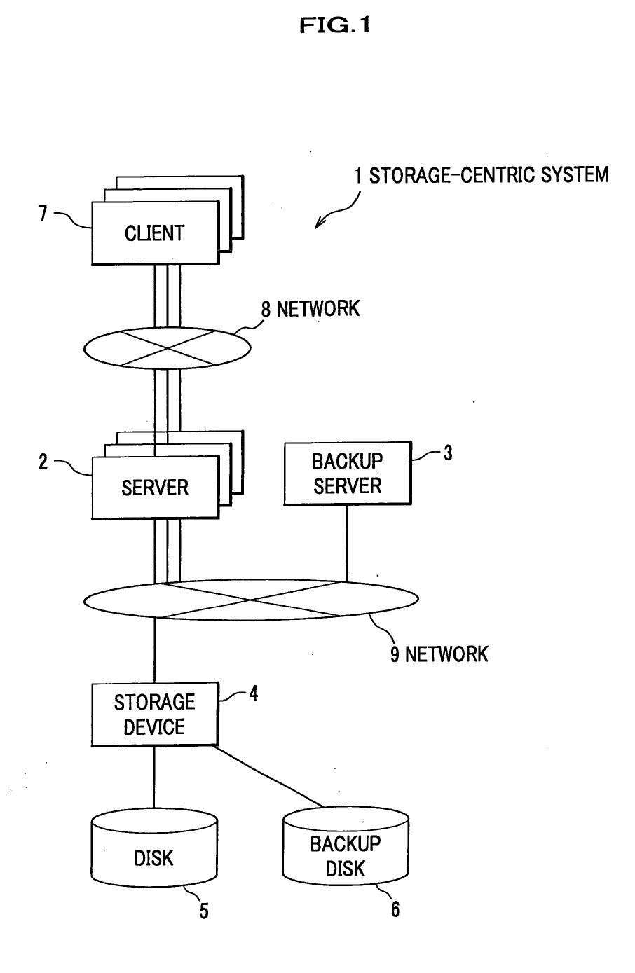

Explanations will be provided hereinafter on a backup system according to an embodiment of the present invention, with reference to drawings. Referring to FIGS. 1 to 3, an explanation will be given on a configuration of the backup system according to the present embodiment.

<System Configuration>

FIG. 1 is a schematic block diagram showing a configuration of a storage-centric system according to the present embodiment.

The storage-centric system 1 comprises servers 2 (also referred to as “computers”), at least one backup server 3, at least one storage device 4 for which a disk 5 and a backup disk 6 as a backup destination for data stored on the disk 5 are provided, clients 7 and networks 8, 9.

The clients 7 are connected with the servers 2 via the network 8, and the clients 7 and the servers 2 are configured in a client/server configuration. This means that a user inputs or outputs data via one of the clients 7, and actual processes are carried out on the server(s) 2.

It is assumed herein that the storage-centric system 1 according to the present embodiment comprises two or more pairs of the clients 7 and the servers 2. Each server 2 is connected with the storage device 4 via the network 9, so that the server 2, serving as an auxiliary memory device 204, can access to the disk 5 connected with the storage device 4.

The storage device 4 manages the disk 5 connected therewith.

The backup server 3 is connected with the storage device 4 via the network 9, and performs a backup process, serving as a backup destination for the disk 5, so as to backup data stored on the disk 5 that is being used by the servers 2 onto the backup disk. It is assumed that iSCSI is used as a communication protocol between the server 2/back-up server 3 and the storage device 4.

Note that a communication protocol between the backup disk 6 and the storage device 4 is not limited to iSCSI.

Although it is assumed herein that the networks 8, 9 are LAN (Local Area Network) including routers and network switches, WAN (Wide Area Network) is also applicable.

<Configuration of Server and Backup Server>

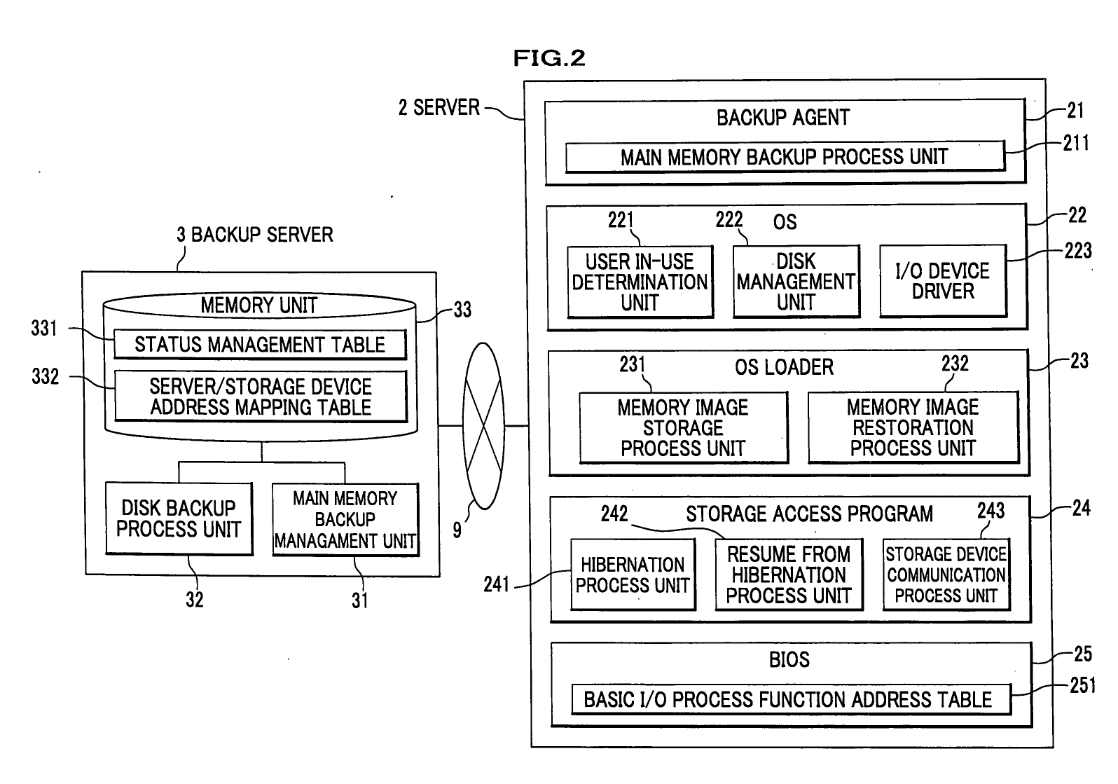

Chiefly referring to FIG. 2 as well as FIG. 1, an explanation will be given on a configuration of the server and the backup server.

FIG. 2 is a schematic block diagram of the server 2 and the backup server 3.

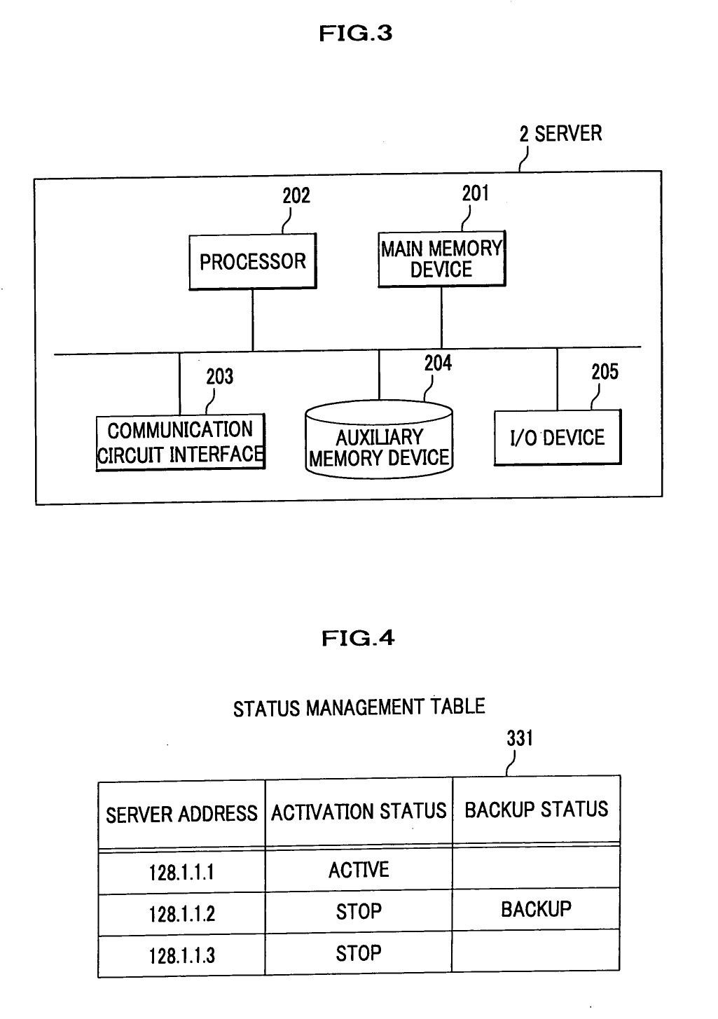

The server 2 includes a BIOS 25, a storage access program 24, an OS loader 23, an OS 22 and a backup agent 21. The BIOS (Basic Input/Output System) 25 is a program to be first performed immediately after the server 2 is powered on. The storage access program 24 is a program to be performed next to the BIOS 25, which reads an OS (Operation System) loader 23 from an appropriate storage device 4 onto a main memory device 201 (see FIG. 3). The OS loader 23 is a program to be performed following the storage access program 24, which reads files that are stored on the storage device 4 in a file format of the OS 22 and that constitutes the OS 22, onto the memory device 201. The OS 22 provides the user with an environment for processing the server 2. The backup agent 21 has control over the data backup process of the backup system according to the present embodiment.

The backup agent 21 includes a main memory backup process unit 211 having control over the backup process on the server 2. The OS 22 includes a disk management unit 222 managing and determining whether or not the server 2 is connected (or mounted) with the disk 5, and an I/O device driver 223 for monitoring information inputted via an I/O device 205 (see FIG. 3) or the like.

The OS loader 23 includes a memory image storage process unit 231 and a memory image restoration process unit 232. The memory image storage process unit 231 performs a process of sending the BIOS 25 a write request including memory images that are data stored on the main memory device 201, or the like. The memory image restoration process unit 232 performs a process of sending the BIOS 25 a read request to read memory images from the disk 5, or the like.

The storage access program 24 includes a hibernation process unit 241 for sending the storage device 4 memory images at a time of going into hibernation, or the like, and a storage device communication process unit 243 for determining a connection status between the storage device 4 and the server 2, or the like, in addition to an ordinary boot program including a resume from hibernation process unit 242 for performing a process of reading memory images from the storage device 4 at a time of resume from hibernation.

The BIOS 25 is a program to be executed immediately after the server 2 is powered on. The BIOS 25 includes a basic I/O process function address table 251 that stores memory addresses to be inquired when the BIOS 25 calls each program.

The backup server 3 is a computer for managing the backup process.

The backup server 3 includes a main memory backup management unit 31, a disk backup process unit 32 and a memory unit 33. The main memory backup management unit 31 sends a notice of a backup start and updates a status management table 331. The disk backup process unit 32 copies data stored on the disk 5 onto the backup disk 6 so as to provide backup for the disk 5. The memory unit 33 stores information necessary for the backup process.

The memory unit 33 includes the status management table 331 and a server/storage device address mapping table 332. The status management table 331 manages a status of the disk 5, and the server/storage device address mapping table 332 stores information on associations between the server 2 and the storage device 4 or the disk 5.

<Hardware Configuration>

FIG. 3 is a schematic block diagram showing a hardware configuration of the servers 2.

As shown in FIG. 3, the server 2 includes a processor 202 constituted by a CPU (Central Processing Unit), etc., the main memory device 201 such as a RAM (Random Access Memory), a communication circuit interface 203 for handling a process on communication of an internal interface with externals, an auxiliary memory device 204 such as a HDD (Hard Disk Drive) and an I/O device 205 such as a keyboard or a display.

Each component in FIG. 2 is realized when a program stored on the disk 5, as shown in FIG. 1, is developed on the main memory device 201 and the processor 202 executes the developed program.

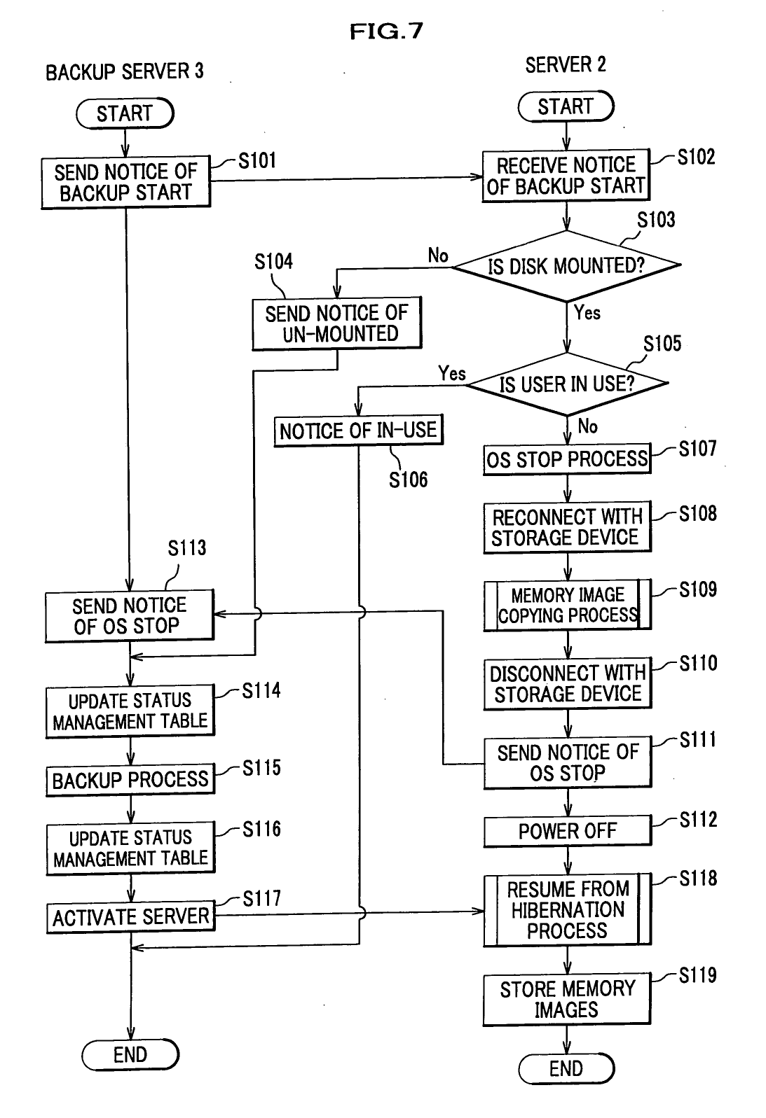

The backup server 3, the storage device 4 and the client 7 have the same hardware configuration as that of the server 2. A program stored on each auxiliary memory device 204 is activated on the main memory device 201 and the processor 202 executes the developed program so as to execute each unit shown in FIG. 2 and each process shown in FIGS. 7 to 10 (described later).

<Status Management Table>

FIG. 4 is a block diagram showing the status management table 331.

The status management table 331 includes each server address which is an IP address of each server 2, a server 2 status (“Stop” or “Active”) corresponding to the address of the related server 2, and a backup status (“Backup” or empty) indicating whether or not the backup server 3 is in a process of backing up memory images of the server 2 corresponding to the related server address. The status management table 331 manages these items of each server 2, as a record by associating each other.

<Server/Storage Device Address Mapping Table>

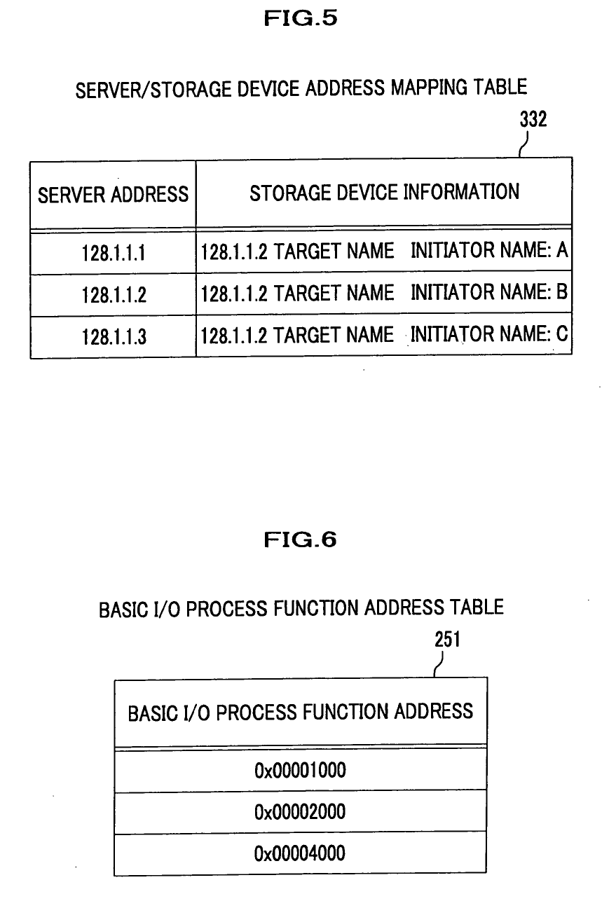

FIG. 5 shows a structure of the server/storage device address mapping table 332.

The server server/storage device address mapping table 332 includes server addresses each of which is an IP address of the server 2, and storage device information that is information on the storage device 4 and the disk 5 (such as an IP address of the storage device 4, a target name to identify the disk 5, an initiator name to identify the server 2). The server server/storage device address mapping table 332 manages these items of each server 2, as a record by associating with each other.

<Basic I/O Process Function Address Table>

FIG. 6 shows a structure of the basic I/O process function address table 251 that the BIOS 25 stores.

The basic I/O process function address table 25 stores memory addresses to be looked up by the BIOS 25 when the BIOS 25 calls each program. If one of programs that the BIOS 25 stores (mostly programs for hardware I/O process such as a read/write program for reading/writing data onto the disk 5) is used, the program is activated by shifting control of the processor 202 to a memory address stored in a predetermined line (such as a memory address for writing data from the disk 5 is in a fifth line) of the basic I/O process function address table 25.

Explanations will be given hereinafter on data backup processes according to the present embodiment, referring to FIGS. 1 to 6.

<General Process>

Chiefly referring to FIG. 7 as well as FIGS. 1, 2 and 4, an explanation will be given on a general data backup process according to the present embodiment.

FIG. 7 is a flow chart showing a backup flow according to the present embodiment.

The main memory backup management unit 31 of the backup server 3 sends the server 2 a notice that a backup process has started (S110).

Receiving the notice of backup start at S102, the main memory backup process unit 211 of the server 2 inquires the disk management unit 222 of the OS 22 which manages the mount status of the disk 5 whether or not the disk 5 is available (herein after referred to as “mounted”), that is, whether or not the disk 5 is mounted, and then the disk management unit 222 determines whether or not the disk 5 is currently mounted by the server 2 (S103).

As a result of the determination at S103, if it is determined that the disk 5 is un-mounted (“No” at S103), the disk management unit 222 of the OS 22 sends a notice that the disk 5 is currently unmounted (notice of unmounted) (S104). Receiving the notice that the disk 5 is currently unmounted, the backup server 3 performs a process of S114.

As a result of the determination at S103, if it is determined that the disk 5 is mounted (“Yes” at S103), the user in-use determination 221 of the OS 22 determines whether or not there is any access to the server 2 so as to determine whether or not the user is in use of the server 2 (S105). Specifically, this determination is made based on results of monitoring operation by the I/O device driver 223 that monitors communication conditions between the clients 7 and the servers 2; start conditions of screen savers of the servers 2; long time period ceasing of inputs and outputs from I/O devices or the like.

As a result of the determination at S105, if it is determined that the server 2 is in use (“Yes” at S105), the user in-use determination unit 221 sends the backup server 3 a notice that the server 2 is currently used (notice of in-use) (S106). Receiving the notice that the server 2 is currently used, the backup server 3 completes the process.

As a result of the determination at S105, if it is determined that the server 2 is not in use (“No” at S105), the main memory backup process unit 211 of the server 2 stores memory images of the main memory device 201 onto the auxiliary memory device 204, and then requests the OS 22 to stop the operation thereof. Receiving this stop request, the OS 22 stops the operation thereof (S107).

Next, the storage device communication process unit 243 provides a reconnection of the networks between the storage device 4 and the server 2 (S108).

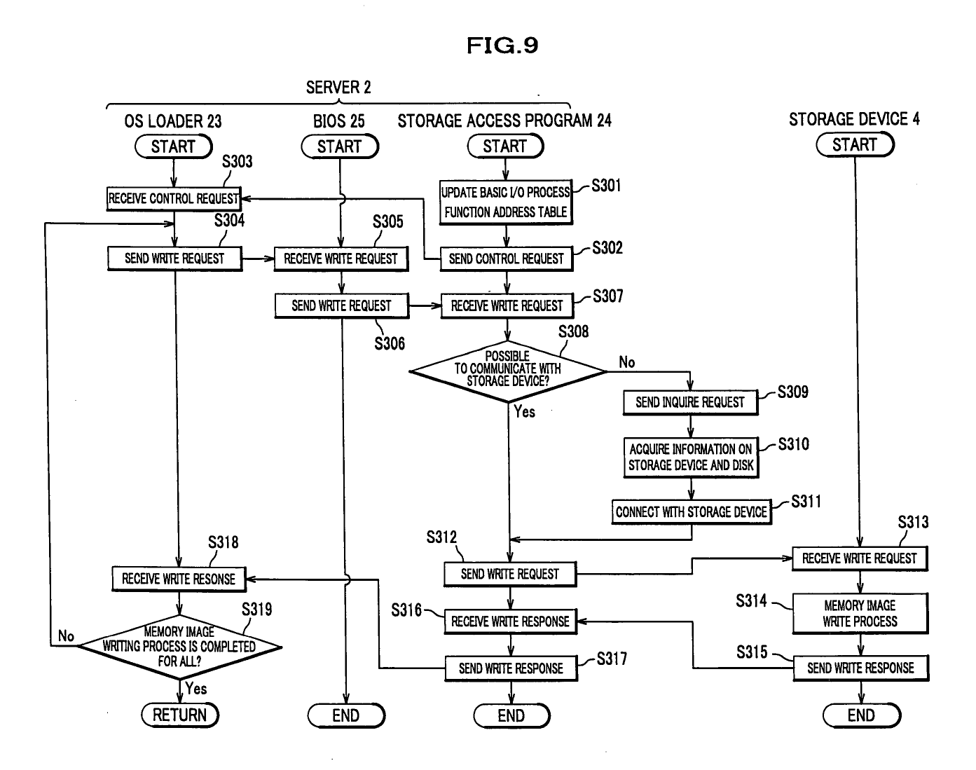

Then, the storage access program 24 performs a memory image copying process to write memory images of the main memory device 201 onto the disk 5 of the storage device 4 (S109). A detailed description of the memory image copying process will be given later with reference to FIG. 9.

The hibernation process unit 241 of the storage access program 24 monitors whether or not the storage access program 24 has halted writing memory images onto the disk 5 in a predetermined time period. If the memory image writing operation of the storage access program 24 has been halted in the predetermined time period, the hibernation process unit 241 determines that the memory image copying process has been completed, and disconnects communication with the storage device 4.

The hibernation process unit 241 sends the backup server 3 a notice that the OS of the server 2 is stopped (notice of OS stop), including the address of the server 2 (i.e. notice that a process for storing memory images has been completed) (Sill), and powers off the server 2 (S112).

At this time, the backup server 3 monitors this notice of the OS stop sent from the hibernation process unit 241. When the backup server 3 has receives the notice of OS stop (S113), the main memory backup management unit 31 acquires a server address included in the notice of OS stop, and then updates to “Backup” a backup status corresponding to the related server address on the status management table 331 (S114).

If the server 2 is powered off, the notice of OS stop cannot be sent. Therefore, the backup server 3 determines that the server 2 is already powered off if the backup server 3 does not receive any notice of OS stop in a predetermined time period, and then shifts to a process at S114 (not shown).

Thereafter, the disk backup process unit 32 of the backup server 3 performs a backup process to backup data stored on the disk 5 (including memory images stored on the disk 5 in the memory image copying process at S109) onto the backup disk 6 (S115).

After the completion of the backup process, the main memory backup management unit 31 updates a backup status for the related server address on the status management table 331 to an empty field (S116).

Next, the main memory backup management unit 31 activates the server 2 (S117).

The activated server 2 performs the resume from a hibernation process (S118), and then stores the read memory images onto the main memory device 201 (S119).

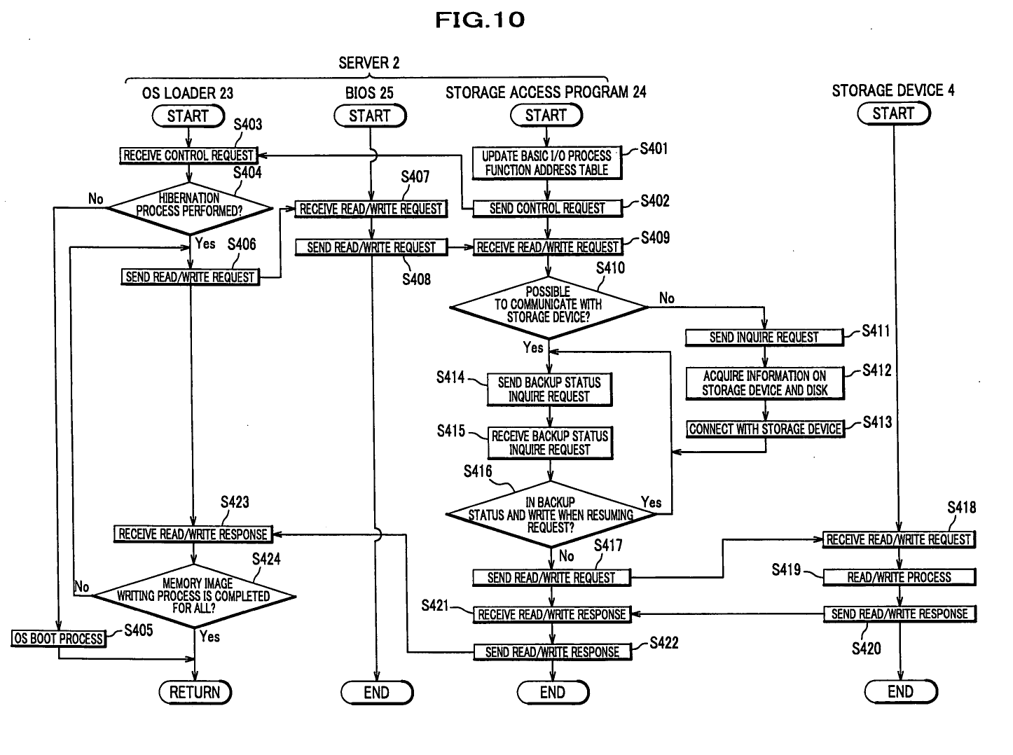

A detailed description of the resume from the hibernation process will be given later, with reference to FIG. 10.

<Hibernation Process (Prior Art)>

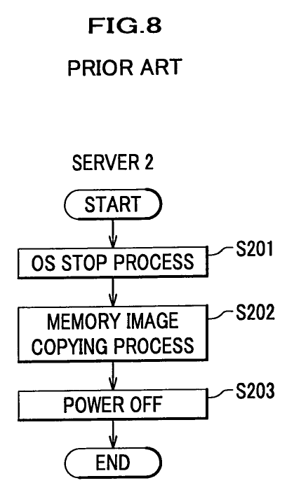

FIG. 8 is a flow chart showing a flow of a hibernation process of the prior art. In contrast with this flow, a description will be give on a difference between the present invention and the prior art.

According to the conventional hibernation process, the OS 22 of the server 2 performs an OS stop process to stop the OS 22 itself (S201), and at the same time gives a control to the OS loader 23.

Then, the OS loader 23 performs the memory image copying process to write data stored on the main memory device 201 onto the “auxiliary memory device 204” (S202), and then powers off the server 2 (S203).

In the conventional hibernation process, the OS loader 23 writes memory images onto the auxiliary memory device 204. On the other hand, in the hibernation process according to the present embodiment, the storage access program 24 takes the place of the OS loader 23 to perform this hibernation process. The storage access program 24 performs an operation of writing memory images onto the disk 5 of the storage device 4, the storage access program 24 further sends the backup server 3 a notice that the hibernation process is completed and a backup status is available on the server 2, which are different from the conventional hibernation process.

The process replaced by the storage access program 24 will be described later in details, with reference to FIGS. 9 and 10.

<Memory Image Copying Process>

Chiefly referring to FIG. 9 as well as FIGS. 1 to 3, FIGS. 5 and 6, the memory image copying process according to the present embodiment will be described, as follow.

FIG. 9 is a flow chart showing a flow of the memory image copying process (S109 in FIG. 7).

First, the hibernation process unit 241 of the storage access program 24 updates a memory address corresponding to the access process function for the auxiliary memory device 204 on the basic 1/O process function address table 251 to a memory address for calling the storage access program 24 (S301).

Next, the hibernation process unit 241 of the storage access program 24 sends the OS loader 23 a control request (S302). Receiving this control request (S303), the OS loader 23 takes the place of controlling the memory image copying process.

The memory image storage process unit 231 of the OS loader 23 sends the BIOS 25 a write request to write memory images stored on the main memory device 201 onto the disk 5 (S304). This write request includes a request from the server 2 for accessing to the storage device 4 and the disk 5, and a part of the memory images (normally in 512 bytes). The reason why the write request includes only a part of the memory images is that it is impossible to send all the memory images at a time to the storage device 4 and the disk 5 because, in the iSCIS scheme, reading and writing operations are performed only on a sector by sector basis (normally in 512 bytes), as described above.

Normally, receiving the write request at S305, the BIOS 25 sends the write request to the OS loader 23, and then the OS loader 23 that has received the write request reads the memory images stored on the auxiliary memory device 204. The memory image storage process is performed in this way.

However, in the present invention, the basic I/O process function address table 251 is updated at S301, so as to call the storage access program 24 instead of the OS loader 23. Therefore, the BIOS 25 sends a write request to the storage access program 24 in accordance with the basic I/O process function address table 251 (S306), and then the storage access program 24 receives the write request (S307), whereby the storage access program 24 is called. In this way, the control is given to the storage access program 24, which means that the storage access program 24 takes the place of the memory image storage process from the OS loader 23.

Receiving the write request, the storage device communication process unit 243 of the storage access program 24 determines whether or not it is possible to communicate with the storage device 4 (S308).

As a result of the determination, if it is possible to communicate with the storage device 4 (“Yes” at S308), the storage access program 24 proceeds to S312.

As a result of the determination, if it is not possible to communicate with the storage device 4 (“No” at S308), the storage device communication process unit 243 sends an inquiry request to the backup server 3 to inquire information on the storage device 4 and the disk 5 (S309). Note that the inquire request includes a server address of the server 2, at this time.

Receiving the inquire request, the main memory backup management unit 31 of the backup server 3 looks up the server/storage device address mapping table 332 in accordance with the server address included in the inquire request. Then, the main memory backup management unit 31 acquires the information on the storage device 4 and the disk 5 with which the server 2 is to connect, which are stored on the server/storage device address mapping table 332 (e.g. an IP address of the storage device 4 and a target name to identify the disk 5), and then sends the information to the server 2 (not shown). Therefore, the storage device communication process unit 243 acquires the necessary information by receiving the information on the storage device 4 and the disk 5 (S310).

If necessary, the communication circuit interface 203 may be initialized, at this time.

Next, based on the information on the storage device 4 (such as an IP address of the storage device 4) acquired at S310, the storage device communication process unit 243 allows the server 2 to connect with the storage device 4 (S311), so as to establish communication between the server 2 and the storage device 4, and then proceeds to S312.

Then, the hibernation process unit 241 sends the storage device 4 the write request received at S307 (S312).

Receiving the write request from the server 2 (S313), the storage device 4 having been in a standby status makes the storage device 4 itself access to the disk 5, so as to perform a writing process of writing onto the disk 5 a part of the memory images included in the write request (S314).

The storage device 4 sends the server 2 a write response (notice about success/fail in the memory image writing process) (S315).

The storage access program 24 having been in standby in receiving the write response from the server 2 receives the write response (S316). Then, the hibernation process unit 241 sends the OS loader 23 the write request (S317).

Receiving the write response at S318, the memory image storage process unit 231 of the OS loader 23 determines whether or not the memory image writing (copying) process is completed for all the memory images (S319).

It may be determined whether or not the memory image writing (copying) process has been completed in such a manner, for example, that the memory image storage process unit 231 previously calculates size of the entire memory images. The memory image storage process unit 231 monitors the size of each part of the memory images that has been sent to the disk 5, and then determines whether or not the total sizes of the memory images that have been sent to the disk 5 reaches the size of the memory images previously calculated.

As a result at S319, if it is determined that the memory image copying process has been completed (“Yes” at S319), the server 2 proceeds to S110 in FIG. 7.

As a result at the S319, if it is determined that the memory image copying process has not been completed (“No” at S319), the server 2 repeats the steps from S304 to S319 until the memory image copying process is completed.

<Resume from Hibernation Process>

With reference to FIG. 10, as well as FIGS. 1, 2, 4, 5 and 6, an explanation will be given on the resume from hibernation process.

FIG. 10 is a flow chart showing a flow of the resume from hibernation process (S118 in FIG. 7).

When the server 2 is powered on, the BIOS 25 is first activated (“Start” in the flow chart). There are several methods to activate the server 2, for example, by remotely powering the server 2 via the backup server 3 (using Wake On LAN feature that the server 2 possesses), or by merely waiting for a resume from hibernation request from the backup server 3 without powering off the server 2 at S112, so as to allow the storage access program 24 to perform the resume from hibernation process.

The BIOS 25 executes the storage access program 24 by a predetermined method. As mentioned above, the storage access program 24 includes the hibernation process unit 241 and the storage device communication process unit 243, in addition to an ordinary boot program. In an ordinary resume from hibernation process, since the BIOS 25 reads this boot program as soon as the server 2 is activated, there is no necessity to mention that the storage access program 24 into which the boot program has been improved is read by the BIOS 25 as well.

The resume from hibernation process unit 242 of the storage access program 24 updates a memory address corresponding to the access process function for the auxiliary memory device 204 on the basic I/O process function address table 251 to a memory address to call the storage access program 24 (S401).

The resume from hibernation process unit 242 of the storage access program 24 sends the OS loader 23 a control request (S402). When the OS loader 23 receives the control request (S403), the control is given to the OS loader 23. The memory image restoration process unit 232 of the OS loader 23 determines whether or not the server 2 has performed the resume from hibernation process at a previous stop (S404). It may be determined whether or not the server 2 has performed the resume from hibernation process at the last time in such a manner, for example, that the memory image storage process unit 231 sets a flag at a predetermined location on the disk 5 if the resume from hibernation process has been performed after S319 in FIG. 9, and the memory image restoration process unit 232 determines whether or not the flag exists at S404 so as to determine whether or not a resume from hibernation process has been performed.

As a result at the S404, if it is determined that the resume from hibernation process has not been performed (“No” at S404), the OS loader 23 performs an ordinal OS boot process (S405), and then completes the resume from hibernation process.

As a result at the S404, if it is determined that the server 2 has performed the resume from hibernation process (“Yes” at S404), the memory image restoration process unit 232 of the OS loader 23 sends the BIOS 25 a read/write request including either of a read request for reading memory images stored on the auxiliary memory device 204, or a “write when resuming request” (described later) (S406), and then the BIOS 25 receives the read/write request (S407).

Now a specific description will be given on the read/write request.

In the resume from hibernation process, a request sent from the OS loader 23 to the BIOS 25 and the storage access program 24 is mostly a read request for reading memory images. However, it is a fact that there occurs some write requests for writing onto swap files for virtual memory or for resetting a flag. In the present specification, for the sake of distinguishing a writing request used at the time of the memory image copying process as explained in FIG. 9, a write request occurring at the time of the resume from hibernation process is hereinafter referred to as a “write when resuming request”. In addition, a request including a read request or a write when resuming request is hereinafter referred to as a “read/write” request.

Normally, the resume from hibernation process is performed in such that the BIOS 25 sends the OS loader 23 a read/write request, and then the OS loader 23, receiving the read/write request, reads memory images stored on the auxiliary memory device 204.

However, according to the present embodiment, the basic I/O process function address table 251 is changed to call the storage access program 24 instead of the OS loader 23 at S401, whereby the BIOS 25 sends the read/write request to the storage access program 24 in accordance with basic I/O process function address table 251 (S408), and the storage access program 24 receives the read/write request (S409), whereby the storage access program 24 is called and then the control is given thereto. In other words, the storage access program 24 takes the place of the memory image reading (copying) process from the OS loader 23.

Receiving the read/write request at S409, the storage device communication process unit 243 of the storage access program 24 determines whether or not communication with the storage device 4 is available (S410).

An explanation will be omitted on the process at S410, and the processes at from S411 to S413 accompanied by the process at S410 since these processes are the same as at from S308 to S311 in FIG. 9.

Following the above steps, the resume from hibernation process unit 242 of the storage access program 24 sends the backup server 3 a backup status inquire request for inquiring whether or not the disk 5 to be used by the server 2 is in a backup status (S414). Note that the backup status inquire request includes a server address of the server 2.

The main memory backup management unit 31 of the backup server 3 acquires the server address included in the backup status inquire request, and looks up a backup status corresponding to the acquired server address on the status management table 331, and then sends the server 2 a backup inquire response including the backup status (empty or “Backup” or the like) corresponding to the acquired server address (not shown).

Receiving the backup inquire response at S415, the resume from hibernation process unit 242 of the storage access program 24 of the server 2 determines, based on the backup inquire response, whether or not the related disk 5 is in a backup status and the read/write request is a write when resuming request (S416). This is for determining whether or not the desk 5 is in a backup status and the server 2 itself is in operation of writing data onto the disk 5. It may be determined whether or not the read/write request is a write when resuming request in such a manner, for example, that a flag is added to the read/write request, which indicates “0” if the read/write request is a “read request” and “1” if the read/write request is a write when resuming request. This determination may be made by the resume from hibernation process unit 242 depending on the flag.

As a result of the determination at S416, if the disk 5 is in a backup status and the read/write request is a write when resuming request (“Yes” at S416), which means that the disk 5 is in a backup status and the server 2 itself is in operation of writing data onto the disk 5, the storage access program 24 returns to S414, and repeats the steps from S414 to S416 until the backup process is completed. At this time, the server 2 stays in a standby status in (i.e. halts) writing data onto the disk 5.

As a result at S416, if the disk 5 is not in a backup status and the read/write request is not a write when resuming request (i.e. read request) (“No” at S416), which means that the disk 5 is not in a backup status, or the server 2 itself is not in operation of writing data onto the disk 5, the storage access program 24 proceeds to S417.

The process that is carried out at from S414 to S416 provides an effect as follows.

As mentioned above, in the resume from hibernation process, a request sent from the OS loader 23 to the BIOS 25 and the storage access program 24 is mostly a read/write request and there seldom occur write when resuming requests. If the disk 5 is in a backup status, it is impossible for the server 2 to write data onto the disk 5. Nevertheless, it is possible for the server 2 to read data from the disk 5 at this time, even when the disk 5 is in a backup status.

Therefore, if it is determined that the disk 5 is not in a backup status at S416, the memory image reading process is carried out if the read/write request is a read request, and a writing when resuming process for writing onto swap files or resetting a flag are carried out if the read/write request is a write when resuming request.

If it is determined that the read/write request is not a write request at S416, the read/write request is always a read request. For this reason, regardless of whether or not the disk 5 is in a backup status, it is possible to perform the reading process. Accordingly, if it is determined that the read/write request is not a write request at S416, the reading process for reading memory images from the disk 5 is carried out, regardless of whether or not the disk 5 is in a backup status.

This allows that the memory image reading process is performed even when the disk 5 is in a backup status, and some write when resuming requests can be processed after the backup process. Accordingly, it is possible to allow the backup process for the disk 5, along with a restart process thereof, resulting in reduction in a total process time from a beginning of the backup process to a completion of the restart process.

Next, the resume from hibernation process unit 242 sends the storage device 4 the read/write request that has been received at S409 (S417).

When the storage device 4 having been in standby in receiving the read/write request from the server 2 receives the read/write request (S418), the storage 4 allows itself to access to the disk 5, so that the storage device 4 performs via the disk 5 the memory image reading process, or the read/write process that is a writing when resuming process such as writing onto a swap file or resetting a flag, as mentioned above (S419). At this time, when reading the memory images, not all but a part of the memory images is read (normally in 512 bytes).

The storage device 4 sends the server 2 a read/write response such as a notice about success/fail in the memory image reading process and a part of the memory images, or a notice about success/fail in the write when resuming process (S420).

Receiving the read/write response (S421), the resume from hibernation process unit 242 of the storage access program 24 having been in standby in receiving the read/write response from the storage device 4 sends the OS loader 23 the read/write response (S422).

Receiving the read/write response at S423, the memory image restoration process unit 232 of the OS loader 23 determines whether or not the memory image reading process has been completed for all the memory images (S424). To be specific, for example, after the completion of the process at S319, the backup server 3 memorizes the total size of the memory images that have been written, and the resume from hibernation process unit 242 acquires the total size of the written memory images from the backup server 3 after the process at S403. The resume from hibernation process unit 242 also sums each size of memory images at the time of read/write response, and determines whether or not the summed size of the memory images at the time of read/write response reaches the total size of the memory images obtained from the backup server 3.

As a result at S424, if it is determined that the memory image reading process has not been completed for all the memory images (“No” at S424), the server 2 returns to S406, and repeats the steps from S406 to S424.

As a result at S424, if it is determined that the memory image reading process has been completed for all the memory images (“Yes” at S424), the server 2 proceeds to S119 in FIG. 7.

Next, an explanation will be given on a backup device according to another embodiment. In this embodiment, it is assumed that data on the backup disk 6 is shadow images.

The storage device 4 has a shadow imaging function, in which when data is written onto the disk 5, the data is temporary accumulated on the storage device 4, and the accumulated data is reflected onto the backup disk 6 in certain timing.

In the present embodiment, if using this shadow image function, the process at S115 is replaced with a process in which the data accumulated on the storage device 4 is reflected onto the backup disk 6.

As explained above, the present invention provides a storage-centric system using iSCSI that data backup operation for the disk can be performed even in a state in which an operating computer is connected with the system.

The embodiments according to the present invention have been explained as aforementioned. However, the embodiments of the present invention are not limited to those explanations, and those skilled in the art ascertain the essential characteristics of the present invention and can make the various modifications and variations to the present invention to adapt it to various usages and conditions without departing from the spirit and scope of the claims.

What is claimed is:

1. A backup method for a storage-centric system comprising:
at least one storage device comprising a disk as a memory device and a backup disk as a destination for data backup of the disk;
computers each having a main memory device; and
at least one backup server for performing a process to backup data onto the backup disk,
the disk, the storage device, the computers and the backup server communicating with one another via networks, at least among which data is sent and received via a communication protocol based on iSCIS,
the backup method comprising:
allowing each computer
to determine by itself whether or not there is any access to the computer, if it is determined that there is no access to the computer,
to store memory images that are data stored on the main memory device onto the disk, and
to power off the computer by itself, and
allowing the backup server to back up the data stored on the disk onto the backup disk.

2. The backup method according to claim 1, wherein
each computer comprises an OS loader; a storage access program; and BIOS, and
the backup method further comprises:
allowing the OS loader for storing the memory images onto an auxiliary memory device equipped to the computer;
allowing the storage access program for sending the storage device the memory images; and
allowing the BIOS storing a basic I/O process function address table on which memory addresses to be looked up by the BIOS when the BIOS calls each program is stored,
wherein
the storage access program updates a memory address on the basic I/O process function address table to be used for calling the OS loader to a memory address to be used for calling the storage access program itself.

3. The backup method according to claim 1, wherein the backed-up data of the disk includes the memory images.

4. The backup method according to claim 1 further comprising allowing the computer to send the backup server a notice that a process for storing the memory images has been completed, after storing the memory images.

5. The backup method according to claim 1 further comprising allowing the storage device to have a function of accumulating the data that are written onto the disk,
wherein
the backup process includes a process for writing the accumulated data on the storage device.

6. The backup method according to claim 1 further comprising:
allowing the backup server to activate the computer after backing up the data on the disk onto the backup disk; and
allowing the computer to read the memory images stored on the disk, and to store the read memory images onto the main memory device.

7. The backup method according to claim 6, wherein
each computer comprises an OS, a storage access program and a BIOS, and
the backup method further comprises:
allowing the OS loader to store the memory images from an auxiliary memory device equipped to the computer;
allowing the storage access program to read the memory images from the disk via the storage device; and
allowing the BIOS to store a basic I/O process function address table on which memory addresses to be looked up by the BIOS when the BIOS calls each program is stored,
wherein
the storage access program updates a memory address on the basic I/O process function address table to be used for calling the OS loader to a memory address to be used for calling the storage access program itself.

8. The backup method according to claim 6 further comprising
allowing the backup server to stay in a standby status in writing data onto the disk, if
the disk stores a status management table including information on whether or not the disk is in a backup status;
the computer inquires the backup server of whether or not the disk is in a backup status before reading the memory images stored on the disk;
the backup server looks up the status management table and sends the computer information on whether or not the disk is in a backup status;
the computer determines, based on the information, whether or not the disk is in a backup status and the computer itself is in operation of writing data onto the disk; and
the disk is in a backup status and the computer itself is in operation of writing data onto the disk.

9. A backup method for a storage-centric system comprising:
at least one storage device comprising a disk as a memory device and a backup disk as a destination for data backup of the disk;
computers each having a main memory device; and
at least one backup server for performing a process to backup data onto a disk different from the disk,
the disk, the storage device, the computer and the backup server communicating with one another via networks, at least in which data is sent and received via a communication protocol based on iSCIS,
the backup method comprising:
allowing each computer to determine by itself whether or not there is any access to the computer; and
if it is determined that there is no access to the computer,
allowing the computer to store memory images that are data stored on the main memory device onto the disk, and to powers off the computer by itself.

10. The backup method according to claim 9, wherein
each computer comprises an OS loader, a storage access program and a BIOS, and
the backup method further comprises:
the OS loader for storing the memory images onto an auxiliary memory device equipped to the computer;
the storage access program for sending the storage device the memory images; and
the BIOS storing a basic I/O process function address table on which memory addresses to be looked up by the BIOS when the BIOS calls each program is stored,
wherein
the storage access program updates a memory address on the basic I/O process function address table to be used for calling the OS loader to a memory address to be used for calling the storage access program itself.

11. The backup method according to claim 9 further comprising allowing the computer to send the backup server a notice that a process for storing the memory images has been completed, after storing the memory images.

12. The backup method according to claim 9 further comprising:
allowing the computer to be activated by the backup server after the backup process is completed; and
allowing the computer to read memory images stored on the disk, and to stores the read memory images onto the main memory device.

13. The backup method according to claim 12, wherein
each computer comprises an OS loader, a storage access program and a BIOS, and
the backup method further comprises:
allowing the OS loader to read the memory images from an auxiliary memory device equipped to the computer;
allowing the storage access program to read the memory images from the disk; and
allowing the BIOS to store a basic I/O process function address table on which memory addresses to be looked up by the BIOS when the BIOS calls each program is stored,
wherein
the storage access program updates a memory address on the basic I/O process function address table to be used for calling the OS loader to a memory address to be used for calling the storage access program itself.

14. The backup method according to claim 12 further comprising
allowing the computer to stay in a standby status in writing data onto the disk, if
the computer
inquires the backup server of whether or not the disk is in a backup status before reading the memory images stored on the disk,
receives information on whether or not the disk is in a backup status from the backup server, and
determines, based on the information, whether or not the disk is in a backup status, and
is in operation of writing data onto the disk; and
the disk is in a backup status and the computer itself is in operation of writing data onto the disk.

15. A backup method for a storage-centric system comprising:
at least one storage device comprising a disk as a memory device and a backup disk as a destination for data backup of the disk;
computers each having a main memory device; and
at least one backup server for performing a backup process onto the backup disk,
the disk, the storage device, the computers and the backup server communicating with one another via networks, at least among which data is sent and received via a communication protocol based on iSCIS,
the backup method comprising
backing up the data stored on the disk onto the backup disk after receiving from the computer a notice that a process of storing memory images that are data on the main memory device onto the backup disk has been completed.

16. The backup method according to claim 15, wherein the backed-up data of the disk includes the memory images.

17. The backup method according to claim 15 further comprising allowing the backup server to activate the computer after the data stored on the disk is backed up onto the backup disk by the backup server.

18. A backup program for executing the backup method according to claim 1.

19. A backup program for executing the backup method according to claim 9.

20. A backup program for executing the backup method according to claim 15.

21. A storage-centric system comprising:
at least one storage device comprising a disk as a memory device and a backup disk as a destination for data backup of the disk;
computers each having a main memory device; and
at least one backup server for performing a process to backup data onto the backup disk,
the disk, the storage device, the computers and the backup server communicating with one another via networks, at least among which data is sent and received via a communication protocol based on iSCIS,
wherein
each computer determines by itself whether or not there is any access thereto,
if it is determined that there is no access to the computer, the computer stores memory images that are data stored on the main memory device onto the disk, and powers off the computer itself, and
the backup server backs up the data stored on the disk onto the backup disk.

22. A storage-centric system comprising:
at least one storage device comprising a disk as a memory device and a backup disk as a destination for data backup of the disk;
computers each having a main memory device; and
at least one backup server for performing a process to backup data onto a disk different from the disk, the disk, the storage device, the computer and the backup server communicating with one another via networks, at least in which data is sent and received via a communication protocol based on iSCIS,
wherein
each computer determines by itself whether or not there is any access to the computer,
if it is determined that there is no access to the computer, the computer stores memory images that are data stored on the main memory device onto the disk, and then powers off the computer by itself.

23. A storage-centric system comprising:
at least one storage device comprising a disk as a memory device and a backup disk as a destination for data backup of the disk;
computers each having a main memory device; and
at least one backup server for performing a backup process onto the backup disk, the disk, the storage device, the computers and the backup server communicating with one another via networks, at least among which data is sent and received via a communication protocol based on iSCIS,
wherein
the data stored on the disk is backed up onto the backup disk after receiving from the computer a notice that a process of storing memory images that are data on the main memory device onto the backup disk has been completed.
